(19) United States
(12) Patent Application Publication
(10) Pub. No.: US 2017/0267843 A1
(43) Pub. Date: Sep. 21, 2017

(54) Rubber Composition and Pneumatic Tire Using Same

(71) Applicant: The Yokohama Rubber Co., LTD., Minato-ku, Tokyo (JP)

(72) Inventors: Shun Sato, Hiratsuka-shi, Kanagawa (JP); Yusuke Tanabe, Hiratsuka-shi, Kanagawa (JP)

(21) Appl. No.: 15/329,969

(22) PCT Filed: Jul. 28, 2015
(86) PCT No.: PCT/JP2015/071389

§ 371 Date: Jan. 27, 2017

(30) Foreign Application Priority Data
Jul. 29, 2014 (JP) 2014-153939

(51) Int. Cl. C08L 9/06; B60C 1/00

(52) U.S. Cl. CPC C08L 9/06; B60C 1/0016; C08L 2205/035

(57) ABSTRACT

The present technology provides a rubber composition comprising: a diene rubber, an acid-modified polyolefin (A), and a polyolefin (B). The mass ratio of the acid-modified polyolefin (A) to the polyolefin (B) is from 1:5 to 5:1. The total amount of the acid-modified polyolefin (A) and the polyolefin (B) is from 3 to 60 parts by mass per 100 parts by mass of the diene rubber. The present technology also provides a pneumatic tire that uses the rubber composition.

### TECHNICAL FIELD

The present technology relates to a rubber composition and a pneumatic tire using the same.

### BACKGROUND ART

In recent years, there has been a demand for environmental consideration with regard to even pneumatic tires from the perspective of protecting the global environment. Specifically, there has been a demand for performance which enhances fuel economy while maintaining high strength.

In order to improve fuel economy, a pneumatic tire should be produced using a rubber composition capable of suppressing heat build-up during travel. In particular, it is thought that fuel economy can be improved by reducing the heat build-up in cap treads, which are in contact with the road surface during travel, and sidewalls, which repeatedly undergo substantial deformation during travel.

To increase G′ (indicator of storage modulus) used during calculation of tan δ, Japanese Unexamined Patent Application Publication No. 2004-524420A provides tire components including tire treads comprising a vulcanized rubber, an inorganic filler, and a modified rubber that contains i) pendent or terminal functional groups containing carboxylic acid or anhydride groups or ii) a polymerized metal salt of an unsaturated carboxylic acid.

When the inventors of the present technology studied the rubber composition described in Japanese Unexamined Patent Application Publication No. 2004-524420A, it was found that modulus of a rubber obtained from such a rubber composition (especially, modulus at high temperatures) may be reduced.

Furthermore, the inventors of the present technology also found that, even when polyolefin was simply added to the rubber composition, the rubber composition exhibited poor low heat build-up.

### SUMMARY

The present technology provides: a rubber composition that makes it possible to increase the modulus thereof while excellent low heat build-up is maintained; and a pneumatic tire that uses the rubber composition.

The inventors of the present technology found that a rubber composition which contains a diene rubber, an acid-modified polyolefin (A), and a polyolefin (B) and in which the quantitative ratio and the total amount of the acid-modified polyolefin (A) and the polyolefin (B) are within particular ranges makes it possible to increase the modulus at low to high temperatures while excellent low heat build-up is maintained, and thus completed the present technology.

Specifically, the inventors of the present technology found the following features.

1. A rubber composition comprising: a diene rubber, an acid-modified polyolefin (A), and a polyolefin (B);

a mass ratio of the acid-modified polyolefin (A) to the polyolefin (B) being from 1:5 to 5:1; and

a total amount of the acid-modified polyolefin (A) and the polyolefin (B) being from 3 to 60 parts by mass per 100 parts by mass of the diene rubber.

2. The rubber composition according to 1 above, further comprising silica, an amount of the silica being from 5 to 150 parts by mass per 100 parts by mass of the diene rubber.

3. The rubber composition according to 1 or 2 above, where the acid-modified polyolefin (A) contains a repeating unit formed from at least one selected from the group consisting of ethylene and α-olefins.

4. The rubber composition according to 3 above, where the α-olefin is at least one type selected from the group consisting of propylene, 1-butene, and 1-octene.

5. The rubber composition according to any one of 1 to 4 above, where the polyolefin (B) contains a repeating unit formed from at least one type selected from the group consisting of ethylene, propylene, 1-butene, and 1-octene.

6. The rubber composition according to any one of 1 to 5 above, where the acid-modified polyolefin (A) is a polyolefin that is modified with maleic anhydride.

7. The rubber composition according to any one of 1 to 6 above, where the acid-modified polyolefin (A) and the polyolefin (B) are mixed in advance.

8. A pneumatic tire comprising the rubber composition according to any one of 1 to 7 above in a structural member thereof.

9. The pneumatic tire according to 8 above, where the structural member is a cap tread.

According to the present technology, a rubber composition that makes it possible to increase the modulus thereof while excellent low heat build-up is maintained; and a pneumatic tire that uses the rubber composition can be provided.

### BRIEF DESCRIPTION OF DRAWING

FIG. 1 is a schematic partial cross-sectional view of a tire that illustrates one embodiment of a pneumatic tire of the present technology.

### DETAILED DESCRIPTION

### Rubber Composition

The rubber composition of the present technology is

a rubber composition comprising: a diene rubber, an acid-modified polyolefin (A), and a polyolefin (B);

a mass ratio of the acid-modified polyolefin (A) to the polyolefin (B) being from 1:5 to 5:1; and

a total amount of the acid-modified polyolefin (A) and the polyolefin (B) being from 3 to 60 parts by mass per 100 parts by mass of the diene rubber.

In the present technology, by using particular ranges of the mass ratio of the acid-modified polyolefin (A) to the polyolefin (B) and the total amount of the acid-modified polyolefin (A) and the polyolefin (B) relative to the amount of the diene rubber, modulus (especially, modulus at high temperatures) can be made high while excellent low heat build-up is maintained.

Although the reason is not clear in detail, it is assumed to be as follows.

Specifically, an acid-modified polyolefin is considered to have higher affinity with silica due to the presence of an acid-modified group (e.g. a maleic anhydride group), and it is thus thought to contribute to the dispersion of the silica.

Furthermore, the polyolefin moiety contained in the acid-modified polyolefin is hydrophobic; however, the modulus decreases due to some reasons although excellent physical interaction with rubbers is expected.

Therefore, it is conceived that, by adding a polyolefin, the reduction of the modulus due to the acid-modified polyolefin can be recovered and modulus (especially, modulus at high temperatures) can be made high while excellent low heat build-up is maintained.

The components contained in the rubber composition of the present technology will now be explained in detail.

### Diene Rubber

The diene rubber contained in the rubber composition of the present technology is not particularly limited as long as the diene rubber has double bonds in the main chain, and specific examples thereof include natural rubber (NR), isoprene rubber (IR), butadiene rubber (BR), aromatic vinyl-conjugated diene copolymer rubber, chloroprene rubber (CR), acrylonitrile butadiene rubber (NBR), ethylene-propylene-diene copolymer rubber (EPDM), styrene-isoprene rubber, isoprene-butadiene rubber, nitrile rubber, hydrogenated nitrile rubber, and the like. One type of these may be used alone, or two or more types may be used in combination.

Of these, it is preferable to use aromatic vinyl-conjugated diene copolymer rubber, NR, or BR from the perspective of achieving excellent wear resistance and excellent processability.

Examples of the aromatic vinyl-conjugated diene copolymer rubber described above include styrene-butadiene rubber (SBR), styrene-isoprene rubber, styrene-butadiene-isoprene rubber (SBIR), and the like. Of these, SBR is preferable.

The terminal of the aromatic vinyl-conjugated diene copolymer rubber may be modified with a hydroxy group, a polyorganosiloxane group, a carbonyl group, an amino group, or the like.

Furthermore, the weight average molecular weight of the aromatic vinyl-conjugated diene copolymer rubber is not particularly limited but is preferably from 100,000 to 2,500,000 and more preferably from 300,000 to 2,000,000 from the perspective of processability. Note that the weight average molecular weight (Mw) of the aromatic vinyl-conjugated diene copolymer rubber is measured by gel permeation chromatography (GPC) on the basis of polystyrene standard using tetrahydrofuran as a solvent.

The aromatic vinyl-conjugated diene copolymer rubber preferably contains from 20 to 50 mass % of an aromatic vinyl (e.g. styrene), and more preferably contains from 20 to 70 mass % of the vinyl bond content in the conjugated diene, from the perspectives of processability and wear resistance.

In the present technology, the microstructure of the aromatic vinyl-conjugated diene copolymer rubber (e.g. styrene-butadiene rubber) is measured in accordance with JIS (Japanese Industrial Standard) K 6239:2007 (Rubber, raw, S-SBR Determination of the microstructure).

When the diene rubber at least contains an aromatic vinyl-conjugated diene copolymer rubber, the amount of the aromatic vinyl-conjugated diene copolymer rubber contained in the diene rubber is preferably from 30 to 100 mass %, and more preferably from 40 to 90 mass %, from the perspective of further enhancing low heat build-up and from the perspective of a balance of low heat build-up and wet grip performance.

### Acid-Modified Polyolefin (A)

The acid-modified polyolefin (A) contained in the rubber composition of the present technology is a polyolefin that is modified with carboxylic acid.

The backbone of the acid-modified polyolefin (A) may be a homopolymer or a copolymer.

An example of a preferable aspect of the acid-modified polyolefin (A) is one in which a repeating unit formed from at least one type selected from the group consisting of ethylene and α-olefins is contained.

Examples of the α-olefin include at least one type selected from the group consisting of propylene, 1-butene, and 1-octene.

### Polyolefin

Examples of the polyolefin constituting the backbone of the acid-modified polyolefin (A) include: homopolymers, such as polyethylene, polypropylene, polybutene, and polyoctene;

two-component copolymers, such as ethylene/propylene copolymers, ethylene/1-butene copolymers, propylene/1-butene copolymers, propylene/1-hexene copolymers, propylene/4-methyl-1-pentene copolymers, propylene/1-octene copolymers, propylene/l-decene copolymers, propylene/1,4-hexadiene copolymers, propylene/dicyclopentadiene copolymers, propylene/5-ethylidene-2-norbornene copolymers, propylene/2,5-norbornadiene copolymers, propylene/5-ethylidene-2-norbornene copolymers, 1-octene/ethylene copolymers, 1-butene/1-hexene copolymers, 1-butene/4-methyl-1-pentene copolymers, 1-butene/1-octene copolymers, 1-butene/1-decene copolymers, 1-butene/1,4-hexadiene copolymers, 1-butene/dicyclopentadiene copolymers, 1-butene/5-ethylidene-2-norbornene copolymers, 1-butene/2,5-norbornadiene copolymers, and 1-butene/5-ethylidene-2-norbornene copolymers; and

multi-component copolymers, such as ethylene/propylene/1-butene copolymers, ethylene/propylene/1-hexene copolymers, ethylene/propylene/1-pentene copolymers, ethylene/propylene/1-octene copolymers, ethylene/propylene/1-decene copolymers, ethylene/propylene/1,4-hexadiene copolymers, ethylene/propylene/dicyclopentadiene copolymers, ethylene/propylene/5-ethylidene-2-norbornene copolymers, ethylene/propylene/2,5-norbornadiene copolymers, 1-butene/ethylene/propylene copolymers, 1-butene/ethylene/1-hexene copolymers, 1-butene/ethylene/1-octene copolymers, 1-butene/propyl ene/1-octene copolymers, 1-butene/ethylene/1,4-hexadiene copolymers, 1-butene/propylene/1,4-hexadiene copolymers, 1-butene/ethylene/dicyclopentadiene copolymers, 1-butene/propylene/dicyclopentadiene copolymers, 1-butene/ethylene/5-ethylidene-2-norbornene copolymers, 1-butene/propylene/5-ethylidene-2-norbornene copolymers, 1-butene/ethylene/2,5-norbornadiene copolymers, 1-butene/propylene/2,5-norbornadiene copolymers, 1-butene/ethylene/5-ethylidene-2-norbornene copolymers, and 1-butene/propylene/5-ethylidene-2-norbornene copolymers; and the like.

Of these, it is preferable to use polypropylene, polybutene, polyoctene, propylene/ethylene copolymers, 1-butene/ethylene copolymers, 1-butene/propylene copolymers, ethylene/propylene/1-butene copolymers, and 1-octene/ethylene copolymers.

### Carboxylic Acid

Meanwhile, examples of the carboxylic acid that modifies the polyolefin described above include unsaturated carboxylic acid. Specific examples thereof include maleic acid, fumaric acid, acrylic acid, crotonic acid, methacrylic acid, itaconic acid, and acid anhydrides of each of these acids.

Of these, it is preferable to use maleic anhydride, maleic acid, and acrylic acid.

The modified polyolefin (A) is preferably a polyolefin that is modified with maleic anhydride.

The acid-modified polyolefin (A) can be produced by a method that is performed ordinarily. Specific examples thereof include a method in which an unsaturated carboxylic acid is graft-polymerized with the polyolefin described above under ordinarily used conditions such as stirring under heating. Furthermore, a commercially available product may be used as the acid-modified polyolefin (A).

Examples of the commercially available product include maleic anhydride-modified propylene/ethylene copolymers, such as Tafmer MA8510 (manufactured by Mitsui Chemicals, Inc.) and MP0620 (manufactured by Mitsui Chemicals, Inc.); maleic anhydride-modified ethylene/1-butene copolymers, such as Tafmer MH7020 (manufactured by Mitsui Chemicals, Inc.); maleic anhydride-modified polypropylenes, such as Admer QE060 (manufactured by Mitsui Chemicals, Inc.); maleic anhydride-modified polyethylenes, such as Admer NF518 (manufactured by Mitsui Chemicals, Inc.); and the like.

In the present technology, the content of the acid-modified polyolefin (A) is preferably from 1 to 40 parts by mass, and more preferably from 2 to 30 parts by mass, per 100 parts by mass of the diene rubber.

Furthermore, when the rubber composition of the present technology further contains silica, the content of the acid-modified polyolefin (A) is preferably from 0.5 to 50 parts by mass, and more preferably from 1 to 40 parts by mass, per 100 parts by mass of the silica.

### Polyolefin (B)

The polyolefin (B) contained in the rubber composition of the present technology is not particularly limited. Note that, in the present technology, the polyolefin (B) does not contain the acid-modified polyolefin (A).

The polyolefin (B) is preferably a polyolefin that is not modified.

The polyolefin (B) may be a homopolymer or a copolymer.

An example of a preferable aspect of the polyolefin (B) is one in which a repeating unit formed from at least one type selected from the group consisting of ethylene and α-olefins is contained.

Examples of the α-olefin include at least one type selected from the group consisting of propylene, 1-butene, and 1-octene.

The polyolefin (B) preferably contains a repeating unit formed from at least one type selected from the group consisting of ethylene, propylene, 1-butene, and 1-octene.

Examples of the polyolefin (B) include polyolefins that are similar to those constituting the backbone of the acid-modified polyolefin (A).

Of these, it is preferable to use polyethylene, polypropylene, polybutene, polyoctene, a propylene/ethylene copolymer, a 1-butene/ethylene copolymer, a 1-butene/propylene copolymer, an ethylene/propylene/1-butene copolymer, or a 1-octene/ethylene copolymer.

The production of the polyolefin (B) is not particularly limited. The polyolefin (B) may be used alone, or two or more types thereof may be used in combination.

The content of the polyolefin (B) is preferably from 1 to 40 parts by mass, more preferably from 1 to 35 parts by mass, and even more preferably from 2 to 25 parts by mass, per 100 parts by mass of the diene rubber.

In the present technology, the mass ratio of the acid-modified polyolefin (A) to the polyolefin (B) is from 1:5 to 5:1, preferably from 1:4 to 4:1, and more preferably from 1:3 to 3:1.

Furthermore, in the present technology, the total amount of the acid-modified polyolefin (A) and the polyolefin (B) is from 3 to 60 parts by mass, preferably from 4 to 50 parts by mass, and more preferably from 5 to 40 parts by mass, per 100 parts by mass of the diene rubber.

In the present technology, an example of a preferable aspect is one in which the acid-modified polyolefin (A) and the polyolefin (B) are a mixture (master batch) in which the acid-modified polyolefin (A) and the polyolefin (B) are mixed in advance.

The mixing ratio of the acid-modified polyolefin (A) and the polyolefin (B) in the mixture is the same as the mixing ratio described above. A method of mixing is not particularly limited.

### Silica

The rubber composition of the present technology preferably further contains silica. The silica is not particularly limited, and any conventionally known silica that is blended in rubber compositions for use in tires or the like can be used.

Specific examples of the silica include fumed silica, calcined silica, precipitated silica, pulverized silica, molten silica, colloidal silica, and the like. One type of these may be used alone or two or more types of these may be used in combination.

Furthermore, the CTAB (cetyl trimethylammonium bromide) adsorption specific surface area of the silica is preferably from 50 to 300 m²/g, and more preferably from 80 to 250 m²/g, from the perspective of suppressing aggregation of the silica.

Note that the CTAB adsorption specific surface area is a value of the amount of n-hexadecyltrimethylammonium bromide adsorbed to the surface of silica measured in accordance with JIS K6217-3:2001 “Part 3: Method for determining specific surface area—CTAB adsorption method.”

In the present technology, the content of the silica is preferably from 5 to 150 parts by mass, more preferably from 10 to 120 parts by mass, and even more preferably from 20 to 100 parts by mass, per 100 parts by mass of the diene rubber.

### Silane Coupling Agent

The rubber composition of the present technology preferably further contains a silane coupling agent. The silane coupling agent is not particularly limited, and any conventionally known silane coupling agent that is blended in rubber compositions for use in tires or the like can be used.

Specific examples of the silane coupling agent include bis(3-triethoxysilylpropyl)tetrasulfide, bis(3-triethoxysilylpropyl)trisulfide, bis(3-triethoxysilylpropyl)disulfide, bis(2-triethoxysilylethyl)tetrasulfide, bis(3-trimethoxysilylpropyl)tetrasulfide, bis(2-trimethoxysilylethyl)tetrasulfide, 3-mercaptopropyltrimethoxysilane, 3-mercaptopropyltriethoxysilane, 2-mercaptoethyltrimethoxysilane, 2-mercaptoethyltriethoxysilane, 3-trimethoxysilylpropyl-N,N-dimethylthiocarbamoyl tetrasulfide, 3-triethoxysilylpropyl-N,N-dimethylthiocarbamoyl tetrasulfide, 2-triethoxysilylethyl-N,N-dimethylthiocarbamoyl tetrasulfide, 3-trimethoxysilylpropyl benzothiazole tetrasulfide, 3-triethoxysilylpropyl benzothiazole tetrasulfide, 3-triethoxysilylpropyl methacrylate monosulfide, 3-trimethoxysilylpropyl methacrylate monosulfide, bis(3-diethoxymethylsilylpropyl)tetrasulfide, dimethoxymethylsilylpropyl-N,N-dimethylthiocarbamoyl tetrasulfide, dimethoxymethylsilylpropyl benzothiazole tetrasulfide, and the like. One type of these may be used alone or two or more types of these may be used in combination. Furthermore, one type or two or more types of these may be oligomerized in advance and used.

Furthermore, specific examples of the silane coupling agent other than those listed above include mercapto-based silane coupling agents, such as γ-mercaptopropyltriethoxysilane and 3-[ethoxybis(3,6,9,12,15-pentaoxaoctacosan-1-yloxy)silyl]-1-propanethiol; thiocarboxylate-based silane coupling agents, such as 3-octanoylthiopropyltriethoxysilane; thiocyanate-based silane coupling agents, such as 3-thiocyanatepropyltriethoxysilane; and the like. One type of these may be used alone or two or more types of these may be used in combination. Furthermore, one type or two or more types of these may be oligomerized in advance and used.

Of these, from the perspective of effect of enhancing reinforcing properties, it is preferable to use at least one type selected from the group consisting of bis-(3-triethoxysilylpropyl)tetrasulfide and bis-(3-triethoxysilylpropyl)disulfide. Specific examples thereof include Si69 (bis(3-triethoxysilylpropyl)tetrasulfide, manufactured by Evonik Degussa), Si75 (bis(3-triethoxysilylpropyl)disulfide, manufactured by Evonik Degussa), and the like.

The content of the silane coupling agent is preferably 1 part by mass or greater, and more preferably from 1 to 10 parts by mass, per 100 parts by mass of the diene rubber.

Furthermore, the content of the silane coupling agent is preferably from 0.1 to 20 parts by mass, and more preferably from 0.5 to 15 parts by mass, per 100 parts by mass of the silica.

### Carbon Black

The rubber composition of the present technology preferably further contains carbon black.

Specific examples of the carbon black include furnace carbon blacks such as SAF, ISAF, HAF, FEF, GPE, and SRF, and one of these can be used alone, or two or more types can be used in combination.

Moreover, the carbon black is preferably one having a nitrogen specific surface area (N₂SA) of from 10 to 300 m²/g and more preferably from 20 to 200 m²/g from the perspective of processability when the rubber composition is mixed.

Note that the N₂SA is a value of the amount of nitrogen adsorbed to the surface of carbon black, measured in accordance with JIS K6217-2:2001, “Part 2: Determination of specific surface area—Nitrogen adsorption methods—Single-point procedures”.

The content of the carbon black is preferably from 1 to 100 parts by mass, and more preferably from 5 to 80 parts by mass, per 100 parts by mass of the diene rubber.

### Other Components

The rubber composition of the present technology may contain, in addition to the components described above, an additive that is typically used in rubber compositions for tires including: a filler, such as calcium carbonate; a chemical foaming agent, such as a hollow polymer; a vulcanizing agent, such as sulfur; a sulfenamide-based, guanidine-based, thiazole-based, thiourea-based, or thiuram-based vulcanization accelerator; a vulcanization accelerator aid, such as zinc oxide and stearic acid; wax; aroma oil; an amine-based anti-aging agent, such as paraphenylene diamines (e.g. N,N′-di-2-naphthyl-p-phenylenediamine, N-1,3-dimethylbutyl-N′-phenyl-p-phenylenediamine, or the like), ketone-amine condensates (e.g. 2,2,4-trimethyl-1,2-dihydroquinoline or the like); a plasticizer; and the like.

The compounded amount of these additives may be any conventional amount, as long as the object of the present technology is not impaired. For example, the compounded amounts per 100 parts by mass of the diene rubber may be:

sulfur: from 0.5 to 5 parts by mass,

vulcanization accelerator: from 0.1 to 5 parts by mass,

vulcanization accelerator aid: from 0.1 to 10 parts by mass,

anti-aging agent: from 0.5 to 5 parts by mass,

wax: from 1 to 10 parts by mass, and

aroma oil: from 5 to 30 parts by mass.

### Method for Producing Rubber Composition

There are no particular restrictions to the method for producing the rubber composition of the present technology, and an example is the method whereby each of the above-mentioned components is kneaded using a publicly known method and device (such as a Banbury mixer, kneader, or roll).

In addition, the rubber composition of the present technology can be vulcanized or crosslinked under conventional, publicly known vulcanizing or crosslinking conditions.

Pneumatic Tire

The pneumatic tire of the present technology (also simply called the “tire of the present technology” hereafter) is a pneumatic tire including the rubber composition of the present technology described above in a structural (rubber) member thereof.

Here, the structural member including the rubber composition of the present technology is not particularly limited, but examples include a tire tread portion, a sidewall portion, a bead portion, a member for covering a belt layer, a member for covering a carcass layer, and an inner liner. Of these, a tire tread portion is preferable.

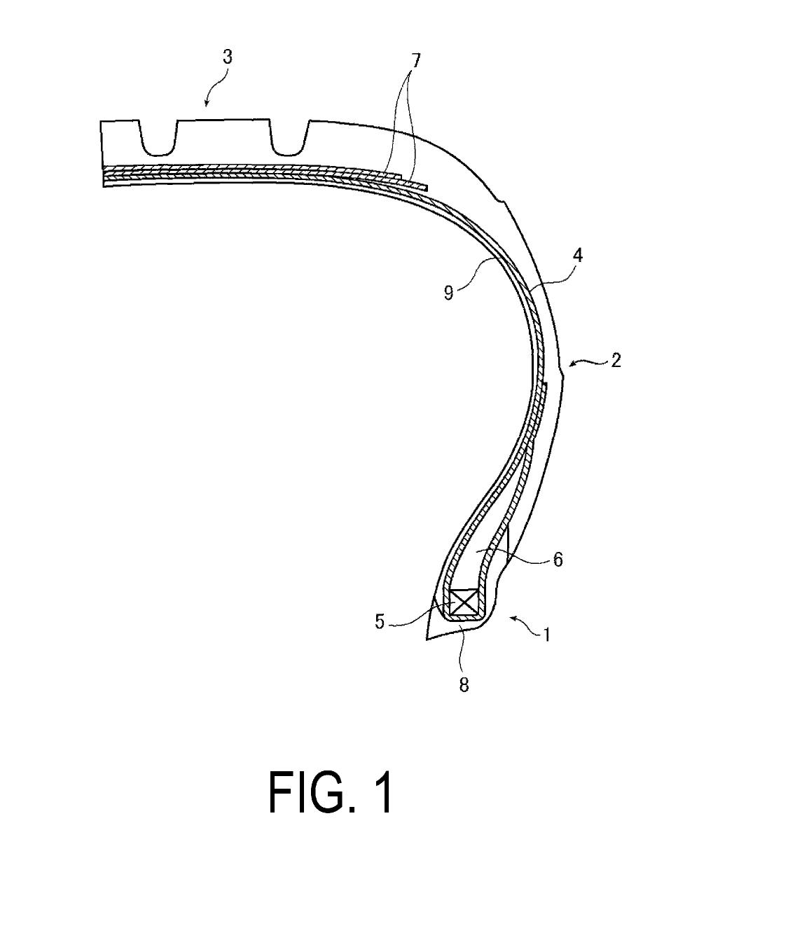

FIG. 1 is a schematic partial cross-sectional view of a tire that illustrates one embodiment of a tire of the present technology, but the tire of the present technology is not limited to the embodiment illustrated in FIG. 1.

In FIG. 1, reference sign 1 indicates a bead portion, reference sign 2 indicates a sidewall portion, and reference sign 3 indicates a tire tread portion.

In addition, a carcass layer 4, in which fiber cords are embedded, is mounted between a left-right pair of the bead portions 1, and ends of the carcass layer 4 are turned up around bead cores 5 and bead fillers 6 from an inner side to an outer side of the tire.

In the tire tread portion 3, a belt layer 7 is provided along the entire circumference of the tire on the outer side of the carcass layer 4.

Additionally, rim cushions 8 are provided in parts of the bead portions 1 that are in contact with a rim.

In addition, an inner liner 9 is provided on the inside surface of the pneumatic tire in order to prevent the air filling the inside of the tire from leaking to the outside of the tire.

When the rubber composition of the present technology is used in a cap tread of a tire tread portion for example, the tire of the present technology can achieve high modulus while excellent low heat build-up is maintained.

Furthermore, the tire of the present technology can be produced by, for example, forming a cap tread by vulcanization or crosslinking at a temperature corresponding to the type and compounding ratio of the diene rubber, vulcanizing agent or crosslinking agent, and vulcanization or crosslinking accelerator used in the rubber composition of the present technology.

### EXAMPLES

The present technology will now be described in detail using examples. However, the present technology is in no way limited to these examples. Production of composition

Components shown in Table 1 below were blended at the proportions (part by mass) shown in the same table.

Specifically, components shown in Table 1 below except for vulcanization components (sulfur and vulcanization accelerators) were kneaded in a 1.7 L sealed mixer for 5 minutes, and the mixture was discharged outside the mixer when the temperature reached 150° C., to be cooled at room temperature. Thereafter, the mixture and the vulcanization components were kneaded using an open roll to produce a rubber composition.

### Production of Vulcanized Rubber Sheet

A vulcanized rubber sheet was then produced by vulcanizing the rubber composition that was produced as described above for 20 minutes at 160° C. in a mold for Lambourn abrasion (disk having a diameter of 63.5 mm and a thickness of 5 mm).

The following evaluations were performed using the vulcanized rubber sheet produced as described above. The results are shown in Table 1.

### Hardness

For the vulcanized rubber sheet that was produced as described above, the durometer hardness (type A) was measured and evaluated at 20° C. in accordance with JIS K6253-3:2012.

The measurement results are shown as index values with the value of Comparative Example 1 expressed as an index of 100. A larger value indicates superior hardness.

### Stress at a Given Elongation (Sₑ): (Indicator of Modulus)

From the vulcanized rubber sheet produced as described above, a JIS No. 3 dumbbell-shaped test piece was punched out, and tensile test was performed at a tensile rate of 500 mm/min in accordance with JIS K6251:2010 to measure the tensile stress at 100% elongation (100% modulus; hereinafter, abbreviated as “M100”) and the tensile stress at 300% elongation (300% modulus; hereinafter, abbreviated as “M300”) in a condition at 0° C. or 100° C.

The measurement results are shown as index values with the value of Comparative Example 1 expressed as an index of 100. A larger index value indicates greater stress and a higher modulus.

### Impact Resilience (60° C.)

The impact resilience of the vulcanized rubber sheet produced as described above at a temperature of 60° C. was measured in accordance with JIS K6255:2013.

The measurement results are shown as index values with the value of Comparative Example 1 expressed as an index of 100. A larger index value indicates superior impact resilience.

### Tan δ (60° C.)

The value of the loss tangent tan δ (60° C.) was measured for the vulcanized rubber sheet produced as described above with an elongation deformation distortion of 10±2%, an oscillation frequency of 20 Hz, and a temperature of 60° C. using a viscoelastic spectrometer (manufactured by Iwamoto Manufacturing).

The measurement results are shown as index values with the value of Comparative Example 1 expressed as an index of 100. A smaller index value indicates superior low heat build-up.

TABLE 1

| | Comparative | Comparative | | | |
|---|---|---|---|---|---|
| | Example 1 | Example 2 | Example 1 | Example 2 | Example 3 |
| SBR | 80 | 80 | 80 | 80 | 80 |
| BR | 20 | 20 | 20 | 20 | 20 |
| Acid-modified α- | | 1 | 2 | 2 | 2 |
| polyolefin A1 (Mah-EB) | | | | | |
| Acid-modified α- | | | | | |
| polyolefin A2 (Mah-EP) | | | | | |
| Acid-modified α- | | | | | |
| polyolefin A3 (Mah-EB) | | | | | |
| Acid-modified α- | | | | | |
| polyolefin A4 (Mah-EP) | | | | | |
| Polyolefin B1 (PP) | | 1 | 1 | 2 | 8 |
| Polyolefin B2 (PE) | | | | | |
| M/B1 of acid-modified | | | | | |
| polyolefin A.polyolefin | | | | | |
| B (Mah-EB 50/PP 50) | | | | | |
| M/B2 of acid-modified | | | | | |
| polyolefin A/polyolefin | | | | | |
| B (Mah-EB 50/PE 50) | | | | | |
| Acid-modified | 0 | 2 | 3 | 4 | 10 |
| polyolefin A + | | | | | |
| polyolefin B | | | | | |
| Acid-modified | — | 1:1 | 2:1 | 2:2 | 1:4 |
| polyolefin A:polyolefin B | | | | | |
| Silane coupling agent | 3 | 3 | 3 | 3 | 3 |
| Silica | 60 | 60 | 60 | 60 | 60 |
| Carbon black | 5 | 5 | 5 | 5 | 5 |
| Zinc oxide | 3 | 3 | 3 | 3 | 3 |
| Stearic acid | 1 | 1 | 1 | 1 | 1 |
| Anti-aging agent | 1 | 1 | 1 | 1 | 1 |
| Oil | 6 | 6 | 6 | 6 | 6 |
| Sulfur | 2 | 2 | 2 | 2 | 2 |
| Sulfur-containing | 1 | 1 | 1 | 1 | 1 |
| vulcanization | | | | | |
| accelerator (CZ) | | | | | |
| Vulcanization | 0.5 | 0.5 | 0.5 | 0.5 | 0.5 |
| accelerator (DPG) | | | | | |
| Hardness (20° C.) | 100 | 100 | 101 | 103 | 107 |
| M100 (0° C.) | 100 | 100 | 101 | 102 | 106 |
| M100 (100° C.) | 100 | 100 | 100 | 101 | 103 |
| M300 (0° C.) | 100 | 100 | 100 | 101 | 104 |
| M300 (100° C.) | 100 | 99 | 99 | 100 | 102 |
| Impact resilience (60° C.) | 100 | 101 | 103 | 102 | 103 |
| Tan δ (60° C.) | 100 | 99 | 97 | 97 | 97 |

| | | Comparative | Comparative | Comparative |
|---|---|---|---|---|
| | Example 4 | Example 3 | Example 4 | Example 5 |
| SBR | 80 | 80 | 80 | 80 |
| BR | 20 | 20 | 20 | 20 |
| Acid-modified α- | 2 | 8 | | 8 |
| polyolefin A1 (Mah-EB) | | | | |
| Acid-modified α- | | | | |
| polyolefin A2 (Mah-EP) | | | | |
| Acid-modified α- | | | | |
| polyolefin A3 (Mah-EB) | | | | |
| Acid-modified α- | | | | |
| polyolefin A4 (Mah-EP) | | | | |
| Polyolefin B1 (PP) | 10 | | 8 | 1 |
| Polyolefin B2 (PE) | | | | |
| M/B1 of acid-modified | | | | |
| polyolefin A.polyolefin | | | | |
| B (Mah-EB 50/PP 50) | | | | |
| M/B2 of acid-modified | | | | |
| polyolefin A/polyolefin | | | | |
| B (Mah-EB 50/PE 50) | | | | |
| Acid-modified | 12 | 8 | 8 | 9 |
| polyolefin A + | | | | |
| polyolefin B | | | | |
| Acid-modified | 1:5 | 8:0 | 0:8 | 8:1 |
| polyolefin A:polyolefin B | | | | |
| Silane coupling agent | 3 | 3 | 3 | 3 |
| Silica | 60 | 60 | 60 | 60 |
| Carbon black | 5 | 5 | 5 | 5 |
| Zinc oxide | 3 | 3 | 3 | 3 |
| Stearic acid | 1 | 1 | 1 | 1 |
| Anti-aging agent | 1 | 1 | 1 | 1 |
| Oil | 6 | 6 | 6 | 6 |
| Sulfur | 2 | 2 | 2 | 2 |
| Sulfur-containing | 1 | 1 | 1 | 1 |
| vulcanization | | | | |
| accelerator (CZ) | | | | |
| Vulcanization | 0.5 | 0.5 | 0.5 | 0.5 |
| accelerator (DPG) | | | | |
| Hardness (20° C.) | 108 | 102 | 106 | 103 |
| M100 (0° C.) | 107 | 98 | 107 | 98 |
| M100 (100° C.) | 105 | 91 | 104 | 95 |
| M300 (0° C.) | 106 | 93 | 107 | 95 |
| M300 (100° C.) | 104 | 88 | 105 | 94 |
| Impact resilience (60° C.) | 103 | 107 | 96 | 106 |
| Tan δ (60° C.) | 97 | 92 | 106 | 94 |

| | | | Comparative | | |
|---|---|---|---|---|---|
| | Example 5 | Example 6 | Example 6 | Example 7 | Example 8 |
| SBR | 80 | 80 | 80 | 80 | 80 |
| BR | 20 | 20 | 20 | 20 | 20 |
| Acid-modified α- | 8 | 8 | | 8 | 8 |
| polyolefin A1 (Mah-EB) | | | | | |
| Acid-modified α- | | | | | |
| polyolefin A2 (Mah-EP) | | | | | |
| Acid-modified α- | | | 16 | | |
| polyolefin A3 (Mah-EB) | | | | | |
| Acid-modified α- | | | | | |
| polyolefin A4 (Mah-EP) | | | | | |
| Polyolefin B1 (PP) | 2 | 8 | | 32 | 40 |
| Polyolefin B2 (PE) | | | | | |
| M/B1 of acid-modified | | | | | |
| polyolefin A.polyolefin | | | | | |
| B (Mah-EB 50/PP 50) | | | | | |
| M/B2 of acid-modified | | | | | |
| polyolefin A/polyolefin | | | | | |
| B (Mah-EB 50/PE 50) | | | | | |
| Acid-modified | 10 | 16 | 16 | 40 | 48 |
| polyolefin A + | | | | | |
| polyolefin B | | | | | |
| Acid-modified | 4:1 | 4:4 | 16:0 | 1:4 | 1:5 |
| polyolefin A:polyolefin B | | | | | |
| Silane coupling agent | 3 | 3 | 3 | 3 | 3 |
| Silica | 60 | 60 | 60 | 60 | 60 |
| Carbon black | 5 | 5 | 5 | 5 | 5 |
| Zinc oxide | 3 | 3 | 3 | 3 | 3 |
| Stearic acid | 1 | 1 | 1 | 1 | 1 |
| Anti-aging agent | 1 | 1 | 1 | 1 | 1 |
| Oil | 6 | 6 | 6 | 6 | 6 |
| Sulfur | 2 | 2 | 2 | 2 | 2 |
| Sulfur-containing | 1 | 1 | 1 | 1 | 1 |
| vulcanization | | | | | |
| accelerator (CZ) | | | | | |
| Vulcanization | 0.5 | 0.5 | 0.5 | 0.5 | 0.5 |
| accelerator (DPG) | | | | | |
| Hardness (20° C.) | 105 | 105 | 103 | 109 | 112 |
| M100 (0° C.) | 100 | 103 | 99 | 111 | 113 |
| M100 (100° C.) | 98 | 99 | 93 | 112 | 114 |
| M300 (0° C.) | 98 | 102 | 94 | 109 | 110 |
| M300 (100° C.) | 98 | 101 | 90 | 108 | 110 |
| Impact resilience (60° C.) | 105 | 105 | 107 | 103 | 102 |
| Tan δ (60° C.) | 95 | 95 | 92 | 97 | 97 |

| | Comparative | | Example | Comparative |
|---|---|---|---|---|
| | Example 1 | Example 9 | 10 | Example 7 |
| SBR | 80 | 80 | 80 | 80 |
| BR | 20 | 20 | 20 | 20 |
| Acid-modified α- | | 20 | 20 | 20 |
| polyolefin A1 (Mah-EB) | | | | |
| Acid-modified α- | | | | |
| polyolefin A2 (Mah-EP) | | | | |
| Acid-modified α- | | | | |
| polyolefin A3 (Mah-EB) | | | | |
| Acid-modified α- | | | | |
| polyolefin A4 (Mah-EP) | | | | |
| Polyolefin B1 (PP) | | 5 | 40 | 45 |
| Polyolefin B2 (PE) | | | | |
| M/B1 of acid-modified | | | | |
| polyolefin A.polyolefin | | | | |
| B (Mah-EB 50/PP 50) | | | | |
| M/B2 of acid-modified | | | | |
| polyolefin A/polyolefin | | | | |
| B (Mah-EB 50/PE 50) | | | | |
| Acid-modified | 0 | 25 | 60 | 65 |
| polyolefin A + | | | | |
| polyolefin B | | | | |
| Acid-modified | — | 4:1 | 2:4 | 4:9 |
| polyolefin A:polyolefin B | | | | |
| Silane coupling agent | 3 | 3 | 3 | 3 |
| Silica | 60 | 60 | 60 | 60 |
| Carbon black | 5 | 5 | 5 | 5 |
| Zinc oxide | 3 | 3 | 3 | 3 |
| Stearic acid | 1 | 1 | 1 | 1 |
| Anti-aging agent | 1 | 1 | 1 | 1 |
| Oil | 6 | 6 | 6 | 6 |
| Sulfur | 2 | 2 | 2 | 2 |
| Sulfur-containing | 1 | 1 | 1 | 1 |
| vulcanization | | | | |
| accelerator (CZ) | | | | |
| Vulcanization | 0.5 | 0.5 | 0.5 | 0.5 |
| accelerator (DPG) | | | | |
| Hardness (20° C.) | 100 | 108 | 115 | 117 |
| M100 (0° C.) | 100 | 103 | 114 | 116 |
| M100 (100° C.) | 100 | 99 | 108 | 109 |
| M300 (0° C.) | 100 | 99 | 108 | 91 |
| M300 (100° C.) | 100 | 98 | 106 | 88 |
| Impact resilience (60° C.) | 100 | 115 | 110 | 108 |
| Tan δ (60° C.) | 100 | 84 | 93 | 94 |

| | Example | Example | Example | Example | Example | Example |
|---|---|---|---|---|---|---|
| | 11 | 12 | 13 | 14 | 15 | 16 |
| SBR | 80 | 80 | 80 | 80 | 80 | 80 |
| BR | 20 | 20 | 20 | 20 | 20 | 20 |
| Acid-modified α- | 40 | | | | | |
| polyolefin A1 (Mah-EB) | | | | | | |
| Acid-modified α- | | 8 | 8 | | | |
| polyolefin A2 (Mah-EP) | | | | | | |
| Acid-modified α- | | | | | | |
| polyolefin A3 (Mah-EB) | | | | | | |
| Acid-modified α- | | | | 8 | | |
| polyolefin A4 (Mah-EP) | | | | | | |
| Polyolefin B1 (PP) | 20 | | | 8 | | |
| Polyolefin B2 (PE) | | 2 | 8 | | | |
| M/B1 of acid-modified | | | | | 16 | |
| polyolefin A.polyolefin | | | | | | |
| B (Mah-EB 50/PP 50) | | | | | | |
| M/B2 of acid-modified | | | | | | 16 |
| polyolefin A/polyolefin | | | | | | |
| B (Mah-EB 50/PE 50) | | | | | | |
| Acid-modified | 60 | 10 | 16 | 16 | 16 | 16 |
| polyolefin A + | | | | | | |
| polyolefin B | | | | | | |
| Acid-modified | 4:2 | 4:1 | 4:4 | 4:4 | 4:4 | 4:4 |
| polyolefin A:polyolefin B | | | | | | |
| Silane coupling agent | 3 | 3 | 3 | 3 | 3 | 3 |
| Silica | 60 | 60 | 60 | 60 | 60 | 60 |
| Carbon black | 5 | 5 | 5 | 5 | 5 | 5 |
| Zinc oxide | 3 | 3 | 3 | 3 | 3 | 3 |
| Stearic acid | 1 | 1 | 1 | 1 | 1 | 1 |
| Anti-aging agent | 1 | 1 | 1 | 1 | 1 | 1 |
| Oil | 6 | 6 | 6 | 6 | 6 | 6 |
| Sulfur | 2 | 2 | 2 | 2 | 2 | 2 |
| Sulfur-containing | 1 | 1 | 1 | 1 | 1 | 1 |
| vulcanization | | | | | | |
| accelerator (CZ) | | | | | | |
| Vulcanization | 0.5 | 0.5 | 0.5 | 0.5 | 0.5 | 0.5 |
| accelerator (DPG) | | | | | | |
| Hardness (20° C.) | 112 | 107 | 108 | 106 | 106 | 102 |
| M100 (0° C.) | 116 | 104 | 106 | 104 | 104 | 106 |
| M100 (100° C.) | 107 | 101 | 101 | 100 | 100 | 99 |
| M300 (0° C.) | 105 | 102 | 103 | 103 | 103 | 101 |
| M300 (100° C.) | 100 | 98 | 99 | 99 | 103 | 98 |
| Impact resilience (60° C.) | 118 | 107 | 105 | 105 | 107 | 106 |
| Tan δ (60° C.) | 82 | 93 | 95 | 96 | 94 | 93 |

Details of the components described in Table 1 are as follows.
SBR: emulsion polymerized SBR, Nipol 1502 (manufactured by Zeon Corporation)
BR: Nipol BR 1220 (manufactured by Zeon Corporation)
Acid-modified α-polyolefin A1: maleic anhydride-modified ethylene/1-butene copolymer (Tafmer MH7020, manufactured by Mitsui Chemicals, Inc.)
Acid-modified α-polyolefin A2: maleic anhydride-modified propylene/ethylene copolymer (Tafmer MP0620, manufactured by Mitsui Chemicals, Inc.); degree of acid modification of the Tafmer MP0620 is the same as that of the Tafmer MH7020
Acid-modified α-polyolefin A3: maleic anhydride-modified ethylene/1-butene copolymer (Tafmer MP7010, manufactured by Mitsui Chemicals, Inc.); degree of acid modification of the Tafmer MP7010 is the half of that of the Tafmer MH7020 and MP0620
Acid-modified α-polyolefin A4: maleic anhydride-modified polyethylene (Admer NF518, manufactured by Mitsui Chemicals, Inc.)
Polyolefin B1: polypropylene; Prime Polypro E-333GV, manufactured by Prime Polymer Co., Ltd.; melting point: 146° C.
Polyolefin B2: polyethylene; Novatec YF30, manufactured by Japan Polyethylene Corporation; melting point: 108° C.
M/B1 of acid-modified polyolefin A.polyolefin B: master batch in which 50 mass % of the acid-modified α-polyolefin A1 and 50 mass % of the polyolefin B1 were mixed in advance
M/B2 of acid-modified polyolefin A.polyolefin B: master batch in which 50 mass % of the acid-modified α-polyolefin A1 and 50 mass % of the polyolefin B2 were mixed in advance
Silane coupling agent: sulfide-based silane coupling agent; Si69VP (manufactured by Evonik Degussa)
Silica: wet silica (Nipsil AQ, CTAB adsorption specific surface area: 170 m²/g; manufactured by Japan Silica Corporation)
Carbon black: Show Black N339M (manufactured by Showa Cabot K. K.)
Zinc oxide: Zinc oxide III (manufactured by Seido Chemical Industry Co., Ltd.)
Stearic acid: stearic acid beads (manufactured by Nippon Oil & Fats Co., Ltd.)
Anti-aging agent: N-(1,3-dimethylbutyl)-N′-phenyl-p-phenylenediamine (Antigen 6C, manufactured by Sumitomo Chemical Co., Ltd.)
Oil: Extract No. 4 S (manufactured by Showa Shell Sekiyu K. K.)
Sulfur: oil treatment sulfur (manufactured by Karuizawa Refinery Ltd.)
Sulfur-containing vulcanization accelerator (CZ): N-cyclohexyl-2-benzothiazolesulfenamide (Sanceller CM-PO, manufactured by Sanshin Chemical Industry Co., Ltd.)
Vulcanization accelerator (DPG): 1,3-diphenylguanidine (Sanceller D-G, manufactured by Sanshin Chemical Industry Co., Ltd.)

As is clear from the results shown in Table 1 above, when Comparative Examples 3 and 6 (containing no polyolefin B) were compared with Comparative Example 1 as a reference, Comparative Examples 3 and 6 resulted in lower moduli than that of Comparative Example 1.

Comparative Example 4 (containing no acid-modified polyolefin A) resulted in lower impact resilience and inferior low heat build-up than those of Comparative Example 1.

Although Comparative Example 5, in which the mass ratio of the acid-modified polyolefin (A) to the polyolefin (B) was not within the predetermined range, exhibited slightly enhanced modulus than that of Comparative Example 3, Comparative Example 5 did not satisfy the required level.

Comparative Example 2, in which the total amount of the acid-modified polyolefin (A) and the polyolefin (B) was less than the predetermined range, resulted in lower M300 (100° C.) than that of Comparative Example 1.

Comparative Example 7, in which the total amount of the acid-modified polyolefin (A) and the polyolefin (B) was greater than the predetermined range, resulted in lower modulus of M300 than that of Comparative Example 1.

On the other hand, Examples 1 to 16 achieved superior low heat build-up and achieved moduli that were equal to or higher than that of Comparative Example 1. Furthermore, Examples 1 to 16 achieved higher moduli (especially, moduli at high temperatures) than that of Comparative Example 3 while excellent low heat build-up was maintained compared to the case of Comparative Example 3.

Furthermore, Examples 1 to 16 achieved high hardness and high impact resilience.

1. A rubber composition comprising: a diene rubber, an acid-modified polyolefin (A), and a polyolefin (B);
a mass ratio of the acid-modified polyolefin (A) to the polyolefin (B) being from 1:5 to 5:1; and
a total amount of the acid-modified polyolefin (A) and the polyolefin (B) being from 3 to 60 parts by mass per 100 parts by mass of the diene rubber.

2. The rubber composition according to claim 1, further comprising silica, an amount of the silica being from 5 to 150 parts by mass per 100 parts by mass of the diene rubber.

3. The rubber composition according to claim 1, wherein the acid-modified polyolefin (A) contains a repeating unit formed from at least one type selected from the group consisting of ethylene and α-olefins.

4. The rubber composition according to claim 3, wherein the α-olefin is at least one type selected from the group consisting of propylene, 1-butene, and 1-octene.

5. The rubber composition according to claim 1, wherein the polyolefin (B) contains a repeating unit formed from at least one type selected from the group consisting of ethylene, propylene, 1-butene, and 1-octene.

6. The rubber composition according to claim 1, wherein the acid-modified polyolefin (A) is a polyolefin that is modified with maleic anhydride.

7. The rubber composition according to claim 1, wherein the acid-modified polyolefin (A) and the polyolefin (B) are mixed in advance.

8. A pneumatic tire comprising the rubber composition according to claim 1 in a structural member thereof.

9. The pneumatic tire according to claim 8, wherein the structural member is a cap tread.
